(19) United States
(12) Patent Application Publication
(10) Pub. No.: US 2013/0077020 A1
(43) Pub. Date: Mar. 28, 2013

(54) LIGHT GUIDE AND DISPLAY USING IT IN A BACKLIGHT UNIT

(71) Applicants: Stefan ROHRMOSER, Oxford (GB); Tong ZHANG, Abingdon (GB)

(72) Inventors: Stefan ROHRMOSER, Oxford (GB); Tong ZHANG, Abingdon (GB)

(73) Assignee: SHARP KABUSHIKI KAISHA, Osaka (JP)

(21) Appl. No.: 13/247,136

(22) Filed: Sep. 28, 2011

(51) Int. Cl. G02F 1/1335; F21V 8/00; G09F 13/04; F21V 7/00

(52) U.S. Cl. 349/62; 362/609; 362/612; 362/613; 362/615; 362/628

(57) ABSTRACT

A light guide plate includes a first major surface, a second major surface opposite the first major surface, and a pair of opposite primary side surfaces and a pair of opposite secondary side surfaces that are perpendicular to the first and second major surfaces. The light guide plate further includes a plurality of pairs of opposing grooves including a first groove provided on the first major surface and a second groove provided on the second major surface. The light guide plate further includes a plurality of light sources configured relative to the grooves. A backlight unit includes the described light guide plate fixed to a back plate. A liquid crystal display device includes the backlight unit positioned behind a liquid crystal panel.

### TECHNICAL FIELD

The invention relates to a novel light guide plate (LGP) and, more particularly, to a display device and a backlight unit (BLU) using said LGP. Furthermore, the invention relates to a configuration of arranging light sources within a BLU using said novel LGP.

### BACKGROUND ART

A liquid crystal display (LCD) in general includes a liquid crystal panel (LC panel) and a backlight unit (BLU) behind said LC panel which illuminates the LC panel. The LC panel then spatially and temporally modulates the transmission of the light from the BLU in intensity and color through its pixel and sub-pixel structure by making use of the polarisation modulation properties of the liquid crystals contained in said sub-pixels. A bright white and highly uniform backlight is generally needed to achieve good picture quality of the LCD. However, due to the LC panel not being a perfect spatial light modulator, light losses occur and a completely dark pixel is generally not achievable when the BLU illuminates said pixel. For this reason, the contrast ratio of LCDs with a BLU that is only globally dimmable is limited, which reduces the picture quality of such displays.

The advent of the light emitting diode (LED), together with recent developments in the area of the BLU, have enabled local dimming backlights, which provide not only very high contrast ratios but allow strong reductions of the power requirements for an LCD. Current local dimming BLUs are either of the direct lit kind, with a two dimensional array of LEDs behind the LC panel, or of the tiled edge lit kind, with a two dimensional array of LGPs behind the LC panel in which each LGP has its own set of light sources. The direct lit local dimming BLU makes use of a very large number of LEDs and requires a relatively large distance between the LEDs and the LC panel, which makes such an LCD system relatively expensive and sets limit to the thinness of the LCD system. The tiled edge lit local dimming BLU also has drawbacks in that it requires a complicated mechanical assembly of the individual LGPs. Furthermore, this mechanical assembly and thermal management measures can induce brightness non-uniformities.

### SUMMARY OF INVENTION

The current invention overcomes the referenced deficiencies of the described conventional configurations. The invention relates to a novel LGP, and a BLU and LCD display system using the novel LGP. More particularly, the invention relates to an LGP with a first major or top surface and a second major or bottom surface, as well as two (primary and secondary) pairs of side surfaces. Said LGP further is provided with a plurality of pairs of grooves, wherein each pair of grooves includes one groove on the first major or top surface and the second groove offset from the first groove on the second major or bottom surface. Said grooves result in efficiently separating the light in the LGP into different areas, and, therefore the grooves enable local dimming or scanning for a BLU using said LGP. Furthermore, said grooves enable good thermal management by enabling a transformation of thermal expansion into a narrowing of the grooves.

Accordingly, an aspect of the invention is a light guide plate. Exemplary embodiments of the light guide plate include a first major surface; a second major surface opposite the first major surface; a pair of opposite primary side surfaces and a pair of opposite secondary side surfaces that are perpendicular to the first and second major surfaces; and a plurality of pairs of opposing grooves including a first groove provided on the first major surface and a second groove provided on the second major surface.

In another exemplary embodiment of the light guide plate, the plurality of pairs of opposing grooves is a first set of pairs of opposing grooves, and each of the first set of pairs of opposing grooves extends from one primary side surface toward the opposite primary side surface in a direction parallel to the secondary side surfaces.

In another exemplary embodiment of the light guide plate, the plurality of pairs of opposing grooves further comprises a second set of pairs of opposing grooves, and each of the second set of pairs of opposing grooves extends from one secondary side surface toward the opposite secondary side surface in a direction parallel to the primary side surfaces.

In another exemplary embodiment of the light guide plate, a pitch between pairs of the first set of the plurality of grooves is different from a pitch between pairs of the second set of the plurality of grooves.

In another exemplary embodiment of the light guide plate, each of the pairs of opposing grooves extends from one secondary side surface toward the opposite secondary side surface in a direction parallel to the primary side surfaces.

In another exemplary embodiment of the light guide plate, each of the plurality of pairs of opposing grooves extends from one side surface all the way to the opposing side surface.

In another exemplary embodiment of the light guide plate, each of the first grooves has a wedge shape defined by an apex angle and angles of sides of the first groove relative to the first major surface, and each of the second grooves has a wedge shape defined by an apex angle and angles of sides of the second groove relative to the second major surface.

In another exemplary embodiment of the light guide plate, the light guide plate further includes a plurality of light sources.

In another exemplary embodiment of the light guide plate, the plurality of light sources are arranged on at least one of the primary side surfaces in interstitial regions between the pairs of the plurality of grooves.

In another exemplary embodiment of the light guide plate, the plurality of light sources are arranged in linear arrays within either of the plurality of first grooves or second grooves.

In another exemplary embodiment of the light guide plate, the light guide plate further includes a plurality of reflectors, wherein each reflector is positioned adjacent to a corresponding linear array of light sources and directs light from the light sources toward a segment of the light guide plate.

In another exemplary embodiment of the light guide plate, the plurality of light sources further are arranged on at least one of the primary sides in interstitial regions between the pairs of the plurality of grooves.

In another exemplary embodiment of the light guide plate, the plurality of light sources are light emitting diodes.

In another exemplary embodiment of the light guide plate, the light guide plate further includes corrugations on either of the first major surface or the second major surface.

In another exemplary embodiment of the light guide plate, the light guide plate further includes light extraction features provided on either of the first major surface or the second major surface.

In another exemplary embodiment of the light guide plate, the light extraction features are arranged in a two dimensional array.

Another aspect of the invention is a backlight unit. Exemplary embodiments of the backlight unit include the described light guide plate, and a back plate, wherein the light guide plate is fixed to the back plate.

Another aspect of the invention is a liquid crystal display (LCD) device. Exemplary embodiments of the LCD device include the described light guide plate a back plate wherein the light guide plate is fixed to the back plate to form a backlight unit, and an LC panel, wherein the backlight unit is positioned behind the LC panel.

In another exemplary embodiment of the LCD device, the first major surface faces the LC panel, and the second major surface faces the back plate.

In another exemplary embodiment of the LCD device, the LCD device further includes, between the backlight unit and the LC panel, at least one optical sheet, and a diffuser sheet.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIGS. 1a and 1b are schematic diagrams respectively depicting a perspective and a cross sectional partial schematic illustration of a light guide plate featuring a plurality of opposing grooves in accordance with an exemplary embodiment of the current invention.

FIGS. 2a-c are schematic diagrams depicting partial cross sectional schematic illustrations of a light guide plate with opposing grooves in which the spatial and angular dimensions defining said opposing grooves are indicated.

FIGS. 3a and 3b are schematic diagrams respectively depicting a perspective and a cross sectional partial schematic illustration of a light guide plate featuring a plurality of opposing grooves as well as light sources arranged along side surfaces of the light guide plate in accordance with an exemplary embodiment of the current invention.

FIGS. 4a and 4b are schematic diagrams respectively depicting a perspective and a cross sectional partial schematic illustration of a light guide plate featuring a number of opposing grooves as well as light sources received by one of each opposing two grooves in accordance with an exemplary embodiment of the current invention.

FIGS. 5a and 5b are schematic diagrams respectively depicting a perspective and a cross sectional partial schematic illustration of a light guide plate featuring a number of opposing grooves as well as light sources and reflectors received by one of each opposing two grooves in accordance with an exemplary embodiment of the current invention.

FIGS. 6a-c are schematic diagrams respectively depicting partial perspective and cross sectional schematic illustrations of a light guide plate with opposing grooves as well as a number of corrugations on one of the light guide plate's major surfaces in accordance with an exemplary embodiment of the current invention.

FIG. 7 is a schematic diagram depicting a partial perspective schematic illustration of a light guide plate with opposing grooves as well as light extraction features on one of the light guide plate's major surfaces in accordance with an exemplary embodiment of the current invention.

FIG. 8 is a schematic diagram depicting a partial perspective schematic illustration of a light guide plate with opposing grooves parallel to both of the two sets of side surfaces of the light guide plate in accordance with an exemplary embodiment of the current invention.

FIG. 9 is a schematic diagram depicting an LCD device in accordance with exemplary embodiments of the current invention.

### DESCRIPTION OF REFERENCE NUMERALS

1 light guide plate with counter cuts
2 primary side surfaces
3 secondary side surfaces
4a, b top (first major) and bottom (second major) surface
5 pair of opposing grooves
5a, b top (first) and bottom (second) groove
6 light source or LED
7 reflector
8 corrugations
9 light extraction features
10 perpendicular pair of opposing grooves
11 interstitial regions between the groove pairs
12 back plate
13 LC panel
14 optical sheet
15 diffuser
20 LCD device
22 backlight unit (BLU)

### DETAILED DESCRIPTION OF INVENTION

In the following, a description of the current invention is provided with reference to the attached drawings. In such drawings, reference numerals identify similar or identical elements throughout several views.

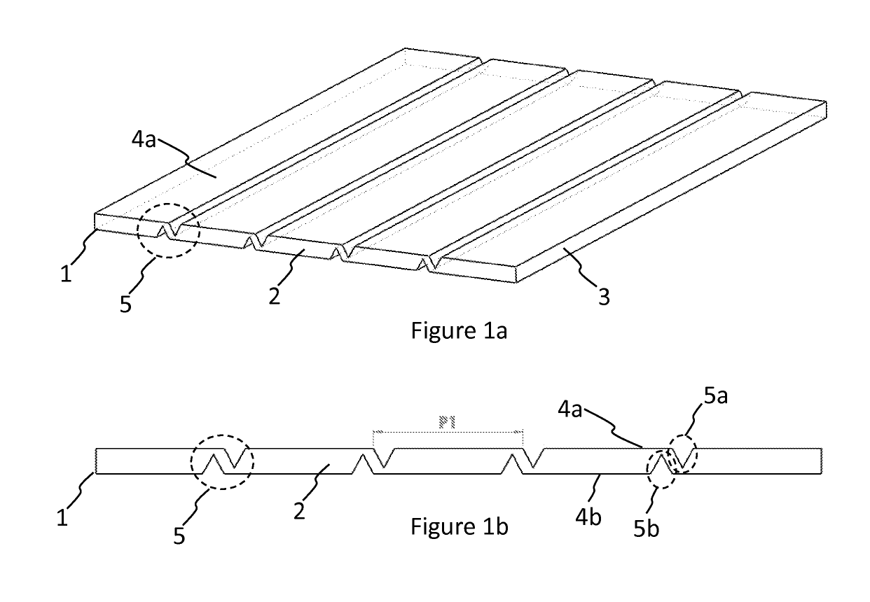

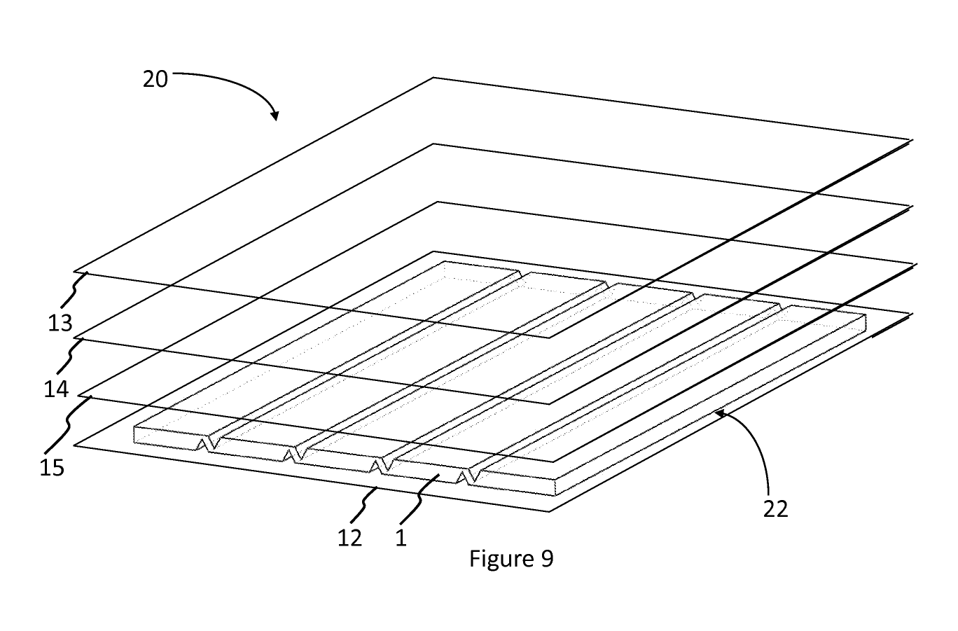

FIGS. 1a and 1b are schematic diagrams respectively depicting perspective and cross sectional partial schematic illustrations of an LGP 1 in accordance with embodiments of the current invention. Said LGP 1 has two primary side surfaces 2 opposite each other and two secondary side surfaces 3 opposite each other and which are perpendicular to the primary side surfaces 2. Furthermore, said LGP 1 has a first major or top surface 4a and a second major or bottom surface 4b, and each of the top and bottom surfaces are perpendicular to both the primary side surfaces 2 and secondary side surfaces 3. In an exemplary LCD device, the first major or top surface 4a faces the LC panel (see FIG. 9 below), and the bottom surface 4b faces the back plate of the BLU (see also FIG. 9 below).

Said LGP 1 is provided with a plurality of pairs of opposing grooves 5. Said pairs of opposing grooves 5 each may include a first or top groove 5a provided on the first major or top surface 4a of said LGP 1, and a second or bottom groove 5b provided on the second major or bottom surface 4b of said LGP 1. The first or top grooves 5a and second or bottom grooves 5b extend in a direction parallel to each other and in a direction parallel to either the primary side surfaces 2 or the secondary side surfaces 3. In the embodiment of FIGS. 1a and 1b, for example, the pairs of opposing grooves extend from one primary side surface toward the opposite primary side surface and in a direction parallel to the secondary side surfaces 3, but the grooves alternatively may be oriented in the cross direction extending from one secondary side surface toward the opposite secondary side surface and parallel to the primary side surfaces 2.

In the depiction of this exemplary embodiment of the invention in FIGS. 1a and 1b, said top groove 5a and bottom groove 5b extend all the way from one primary side surface 2 of the LGP 1 to the opposite primary side surface of the LGP 1. The invention is not limited to such configuration. Rather, the pairs of opposing grooves 5 need not span the whole extent of the LGP 1. The pairs of grooves 5 also may intermittently span the LGP 1. Said pairs of opposing grooves 5 are arranged laterally on the top surface 4a and the bottom surface 4b of the LGP 1 separated by a pitch P1 between each pair of opposing grooves. Although depicted as a constant pitch P1 in FIG. 1b the current invention is not limited to such configuration and a non-constant pitch may be employed as well.

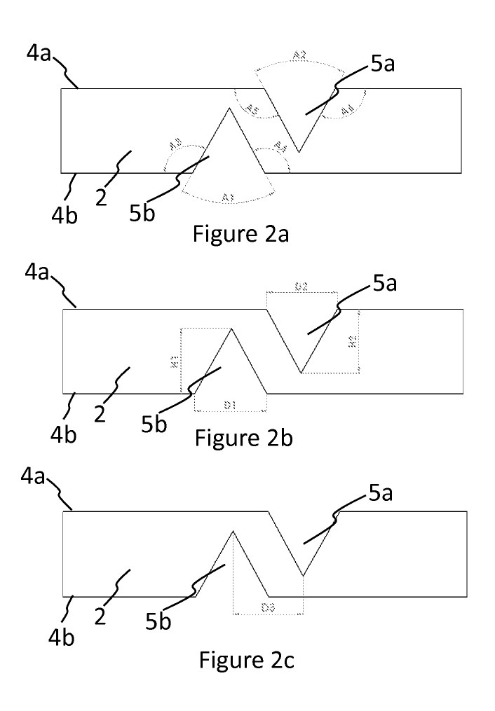

FIGS. 2a-c are schematic diagrams depicting partial cross sectional illustrations of an LGP 1 together with the angular and spatial parameters defining the first or top groove 5a and second or bottom groove 5b. Each of the grooves may have a wedge shape. For example, the bottom groove 5b is defined by the angles A1, A3, and A4 which respectively define the apex angle between an apex and sides of the bottom groove, and the angles of the sides of the bottom groove 5b relative to the second major surface. Comparable features of the top groove 5a are defined by the angles A2, A5, and A6. Furthermore, the bottom groove 5b and the top groove 5a are defined by spatial dimensions for their width, D1 and D2, respectively for the bottom groove 5b and the top groove 5a, and for their depth, H1 and H2, respectively for the bottom groove 5b and the top groove 5a. An additional spatial parameter D3 defines the horizontal distance between the apexes of the top groove 5a and the bottom groove 5b.

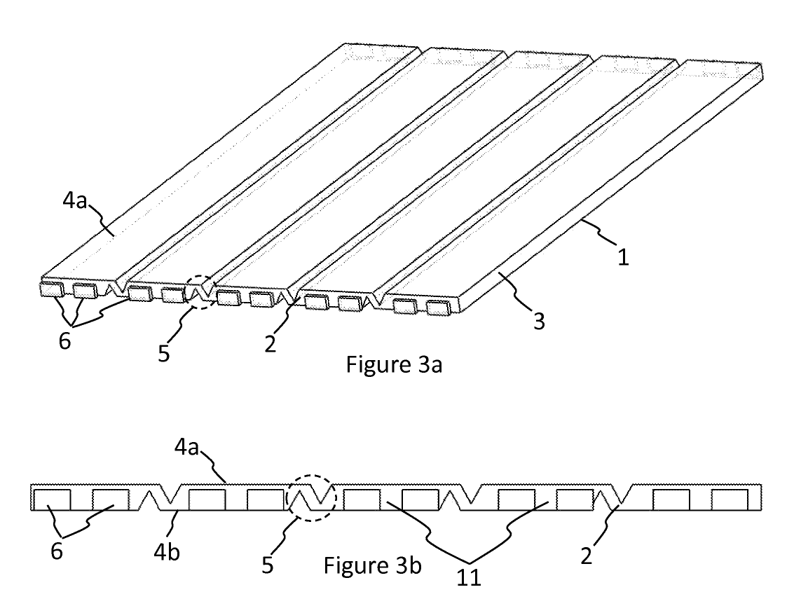

FIGS. 3a and 3b are schematic diagrams respectively depicting a perspective and a cross sectional partial schematic illustration of another exemplary embodiment of the LGP of the current invention. In such embodiment, similarly to the previous embodiment, the LGP 1 is provided with a plurality of pairs of opposing grooves 5. The LGP 1 also may include a plurality of light sources configured relative to the plurality of pairs of grooves. The plurality of light sources each may be a light emitting diode (LED). In the embodiment of FIGS. 3a and 3b, the LGP 1 is further provided with a plurality of light sources 6 that are arranged along at least one, and in another embodiment both, of the primary side surfaces 2 of the LGP 1. Said light sources 6 are arranged in a way that they are located along the interstitial regions 11 of the primary side surfaces 2 that are in between the pairs of opposing grooves 5. FIGS. 3a and 3b depict an example including two light sources within each interstitial region, although such number may vary.

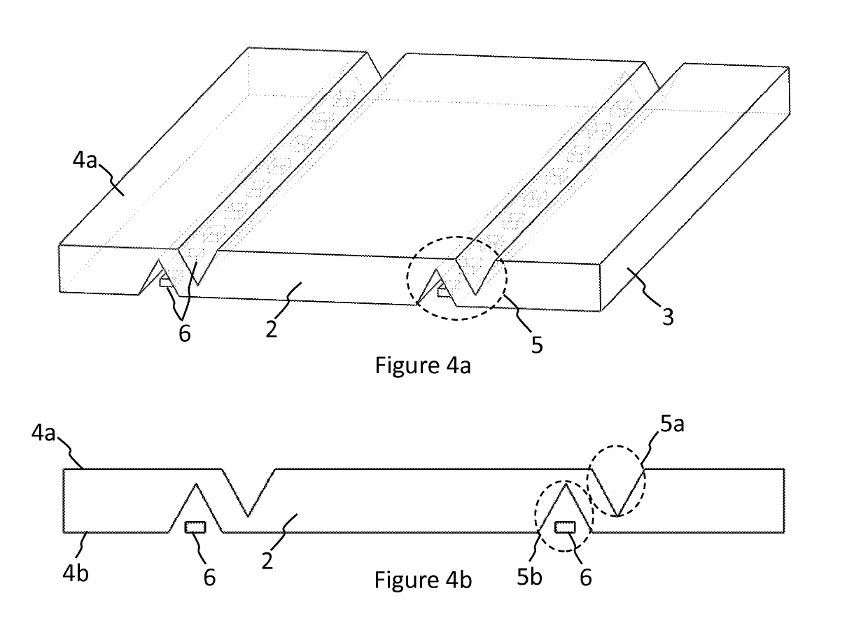

FIGS. 4a and 4b are schematic diagrams respectively depicting a perspective and a cross sectional partial schematic illustration of another exemplary embodiment of the LGP of the current invention. FIGS. 4a and 4b depict another embodiment of the configuration of the light sources relative to the plurality of pairs of grooves. In the embodiment of FIGS. 4a and 4b, The light sources 6 are arranged into linear arrays that are positioned within one of either the first or top groove 5a or the second or bottom groove 5b in a way that the linear arrays of said light sources 6 are aligned with the direction of the top groove 5a or bottom groove 5b. FIGS. 4a and 4b depict the example in which the light sources are provided within the bottom groove 5b. Said light sources 6 may emit light towards the apex of the associated top groove 5a or bottom groove 5b, or alternatively towards one of the sides of the respective groove. This embodiment can be used in combination with light sources 6 arranged along at least one side surface of the LGP 1, as depicted for example in FIGS. 3a and 3b.

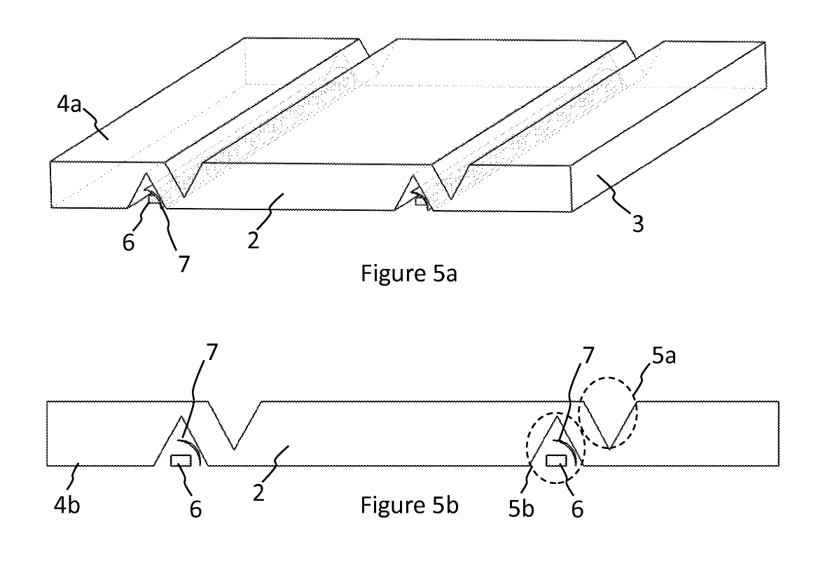

FIGS. 5a and 5b are schematic diagrams respectively depicting a perspective and a cross sectional partial schematic illustration of another exemplary embodiment of the LGP of the current invention. This embodiment bears similarities to the embodiment of FIGS. 4a and 4b. In the embodiment of FIGS. 5a and 5b, a plurality of reflectors 7 is provided in addition to linear arrays of light sources 6 which are both positioned within one of either the first or top groove 5a or the second or bottom groove 5b. FIGS. 5a and 5b depict the example in which the light sources and reflector are provided within the bottom groove 5b. Each reflector is positioned adjacent a corresponding linear array of light sources. Said reflectors 7 direct the light emitted by the light sources 6 towards only one segment of the LGP 1, particularly the portion of the LGP 1 that is separated by two adjacent pairs of opposing grooves 5. This embodiment also can be used in combination with light sources 6 arranged along at least one side surface of the LGP 1, as depicted for example in FIGS. 3a and 3b.

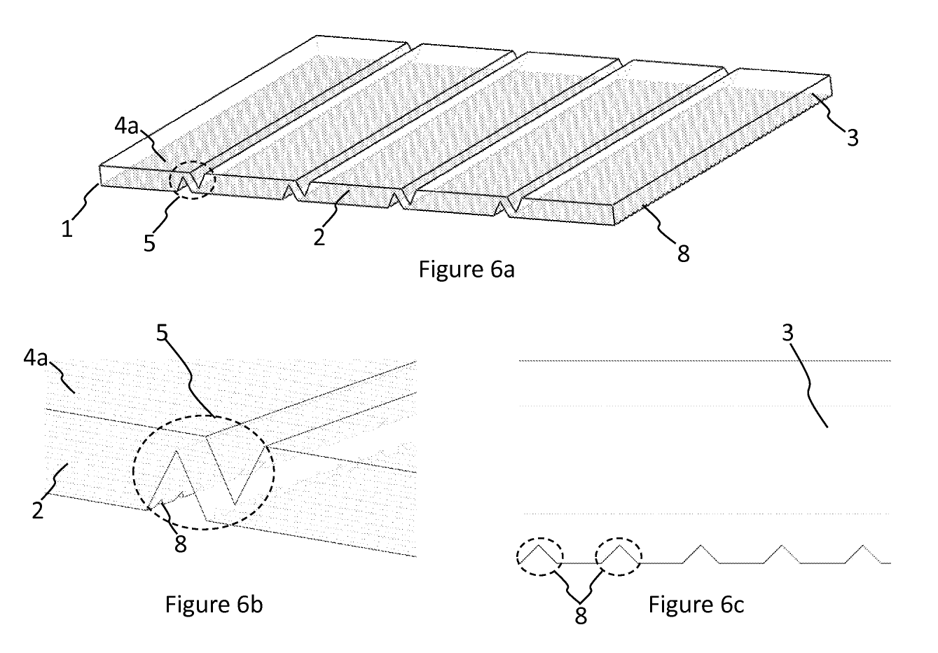

FIGS. 6a-c are schematic diagrams respectively depicting a perspective and a cross sectional partial schematic illustration of another exemplary embodiment of the LGP of the current invention. In the embodiment of FIGS. 6a-c, the LGP 1 is provided with corrugations 8 on either the second major or bottom surface 4b or the first major or top surface 4a of the LGP. FIGS. 6a-c in particular depict the example in which the corrugations are provided on the bottom surface. Said corrugations 8 perform a light management function within the LGP 1. In particular, the light management can be in the form of limiting the lateral spread of light from individual light sources 6 within the LGP 1, or in the form of aiding light extraction from the LGP 1. Said corrugations 8 may be arranged parallel or perpendicular to the pairs of opposing grooves 5. Furthermore, said corrugations 8 may be arranged in an array with either a constant or variable pitch.

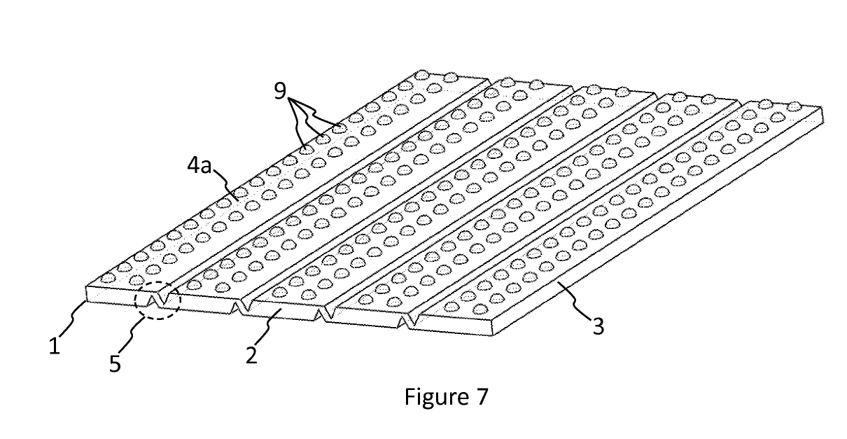

FIG. 7 is a schematic diagram depicting another exemplary embodiment of the current invention. In the embodiment of FIG. 7, the LGP 1 has light extraction features 9 arranged in a two dimensional array on the first major or top surface 4a of the LGP 1. Alternatively, the light extraction features 9 may be may be arranged in a two-dimensional array on the LGP's 1 second major or bottom surface 4b, or the light extraction features may be placed in an arbitrary two dimensional arrangement. Said extraction features 9 are used to manage the light extraction from the LGP 1, and therefore, any suitable shape or form of light extraction features 9 may be employed. For example, the light extraction features may be scattering extraction features, lenticular or cylindrical extraction features, prismatic or conical extraction features, or rectangular extraction features. In one exemplary embodiment, said extraction features 9 may be configured so that the light is extracted uniformly over the whole surface area of the LGP 1.

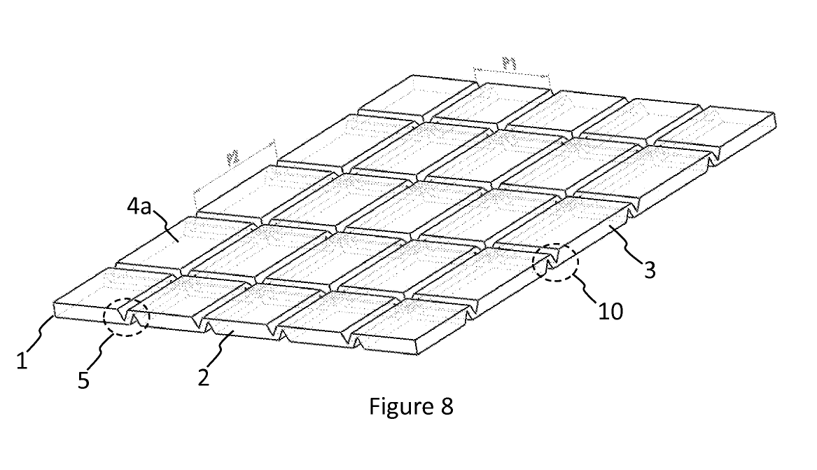

FIG. 8 is a schematic diagram depicting another exemplary embodiment of the current invention. In the embodiment of FIG. 8, the LGP 1 has a first set of pairs of opposing grooves 5 extending from one primary side surface toward the opposite primary surface or fully between the two primary side surfaces 2 and in a direction parallel to the secondary side surfaces. The LGP 1 additionally has a second set of pairs of opposing grooves 10 that are perpendicular to the first set of pairs of opposing grooves and extend from one secondary side surface toward the opposite secondary side surface or fully between the two secondary side surfaces 3 and in a direction parallel to the primary side surfaces. The placement of the perpendicular pairs of opposing grooves 10 is defined by the pitch P2. Said pitch P2 may be a constant or a varying pitch P2 for the placement of said perpendicular pairs of opposing grooves. In addition, the pitch P1 between pairs of the first set of the plurality of grooves may be either the same or different from the pitch P2 between pairs of the second set of the plurality of grooves. Similar to previous embodiments, the embodiment of FIG. 8 can be used with light sources 6 arranged in the top groove 5a or the bottom groove 5b, or along the edges of the LGP 1, or with a combination of such arrangements. Furthermore, the embodiment of FIG. 8 may also employ light sources 6 combined with reflectors 7 similarly to the embodiment of FIGS. 5a and 5b as well.

Although the above embodiments employ certain arrangements of light sources 6 with regards to the LGP 1, any suitable combination of said arrangements of light sources 6 may be employed in the current invention as well.

The various embodiments of the LGP 1 may be employed in an LCD device, such as an LCD display device. FIG. 9 is a schematic diagram depicting an LCD device 20 in accordance with exemplary embodiments of the current invention. For example, a backlight unit (BLU) 22 may include an LGP 1 in accordance with any of the embodiments described above with respect to FIGS. 1-8, fixed to a back plate 12 by any suitable fixation means. As is understood by those skilled in the art, the back plate 12 may be provided with a conventional reflective surface, such as, for example, a coincident reflector sheet. The BLU 22 in turn may be incorporated into an LCD display device 20. For example, the backlight 22 may be arranged behind an LC panel 13, and positioned between the LC panel and the BLU there may also be at least one optical sheet 14 and a diffuser sheet 15.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

Applications for the described invention include LCD backlights for display systems of 20″ or larger display diagonals. The current invention has an advantage over conventional configurations in allowing local dimming of the BLU while maintaining a very thin system dimension, as well as enabling the use of a reduced number of light sources. Local dimming allows reducing the power requirements of the LCD. This is an important requirement for current and future LCD systems due to energy standards and policy restrictions. Furthermore, a locally dimming BLU allows improving the picture quality of the LCD system. The current invention significantly improves the current standard of local dimming backlights by allowing very thin display systems, reducing the number of light sources required, and providing efficient large scale thermal management.

1. A light guide plate comprising:
a first major surface;
a second major surface opposite the first major surface;
a pair of opposite primary side surfaces and a pair of opposite secondary side surfaces that are perpendicular to the first and second major surfaces; and
a plurality of pairs of opposing grooves including a first groove provided on the first major surface and a second groove provided on the second major surface.

2. The light guide plate according to claim 1, wherein the plurality of pairs of opposing grooves is a first set of pairs of opposing grooves, and each of the first set of pairs of opposing grooves extends from one primary side surface toward the opposite primary side surface in a direction parallel to the secondary side surfaces.

3. The light guide plate according to claim 2, wherein the plurality of pairs of opposing grooves further comprises a second set of pairs of opposing grooves, and each of the second set of pairs of opposing grooves extends from one secondary side surface toward the opposite secondary side surface in a direction parallel to the primary side surfaces.

4. The light guide plate according to claim 3, wherein a pitch between pairs of the first set of the plurality of grooves is different from a pitch between pairs of the second set of the plurality of grooves.

5. The light guide plate according to claim 1, wherein each of the pairs of opposing grooves extends from one secondary side surface toward the opposite secondary side surface in a direction parallel to the primary side surfaces.

6. The light guide plate according to claim 1, wherein each of the plurality of pairs of opposing grooves extends from one side surface all the way to the opposing side surface.

7. The light guide plate according to claim 1, wherein each of the first grooves has a wedge shape defined by an apex angle and angles of sides of the first groove relative to the first major surface, and each of the second grooves has a wedge shape defined by an apex angle and angles of sides of the second groove relative to the second major surface.

8. The light guide plate according to claim 1, further comprising a plurality of light sources.

9. The light guide plate according to claim 8, wherein the plurality of light sources are arranged on at least one of the primary side surfaces in interstitial regions between the pairs of the plurality of grooves.

10. The light guide plate according to claim 8, wherein the plurality of light sources are arranged in linear arrays within either of the plurality of first grooves or second grooves.

11. The light guide plate according to claim 10, further comprising a plurality of reflectors, wherein each reflector is positioned adjacent to a corresponding linear array of light sources and directs light from the light sources toward a segment of the light guide plate.

12. The light guide plate according to claim 11, wherein the plurality of light sources further are arranged on at least one of the primary sides in interstitial regions between the pairs of the plurality of grooves.

13. The light guide plate according to claim 8, wherein the plurality of light sources are light emitting diodes.

14. The light guide plate according to claim 1, further comprising corrugations on either of the first major surface or the second major surface.

15. The light guide plate according to claim 1, further comprising light extraction features provided on either of the first major surface or the second major surface.

16. The light guide plate according to claim 15, wherein the light extraction features are arranged in a two dimensional array.

17. A backlight unit comprising:
the light guide plate according to claim 1; and
a back plate, wherein the light guide plate is fixed to the back plate.

18. A liquid crystal display (LCD) device comprising:
the light guide plate according to claim 1;
a back plate, wherein the light guide plate is fixed to the back plate to form a backlight unit; and
an LC panel, wherein the backlight unit is positioned behind the LC panel.

19. The LCD device according to claim 18, wherein the first major surface faces the LC panel, and the second major surface faces the back plate.

20. The LCD device according to claim 18, further comprising between the backlight unit and the LC panel:
at least one optical sheet; and
a diffuser sheet.
